(19) United States
(12) Patent Application Publication
(10) Pub. No.: US 2006/0159296 A1
(43) Pub. Date: Jul. 20, 2006

(54) Stereo speaker system

(76) Inventors: Takashi Kobayashi, Fujiyoshida-shi (JP); Masahito Furuya, Fujiyoshida-shi (JP)

Correspondence Address: BRINKS HOFER GILSON & LIONE, P.O. BOX 10395, CHICAGO, IL, 60610, US

(21) Appl. No.: 11/298,058

(22) Filed: Dec. 9, 2005

(30) Foreign Application Priority Data
Dec. 9, 2004 (JP) JP2004-356105

(51) Int. Cl. H04R 5/02

(52) U.S. Cl. 381/300

(57) ABSTRACT

A stereo speaker system includes a pair of speakers. Each of the speakers includes a frame, a yoke, a diaphragm and a printed circuit board. At least one of the frame, the yoke, the diaphragm and the printed circuit board of one of the speakers is unitarily interconnected to at least corresponding one of the frame, the yoke, the diaphragm and the printed circuit board of the other speaker. This unitary structure reduces the number of required parts and facilitates assembly of the stereo speaker system.

This application claims priority under 35 U.S.C. § 119 to Japanese Patent Application No. 2004-356105 filed Dec. 9, 2004, the entire content of which is hereby incorporated by reference.

### FIELD OF THE INVENTION

The present invention generally relates to stereo speakers for use in a cellular phone and other portable audio devices.

### BACKGROUND OF THE INVENTION

A typical cellular phone includes a single speaker, as shown in Japanese patent application publication No. 2003-143676. There has recently been proposed a cellular phone with two small separate speakers to provide stereophonic sound upon receipt of an incoming signal.

Reference will first be made to a conventional stereo speaker. FIG. 4 shows in plan a known small speaker. FIG. 5 is a sectional view taken on the line V-V in FIG. 4. FIG. 6 is a bottom plan view of the speaker shown in FIG. 4. As shown in FIGS. 4 to 6, a speaker 50 includes an open frame 51 molded of resin. The frame 51 has an annular body 51a and a radial projection 51b radially extending from the annular body 51a and having a generally rectangular shape. The annular body 51a has a central opening 51c and is formed at its outer periphery with a circumferential shoulder 51d. A round yoke 52 is in the form of a cup and is fixedly mounted within the central opening 51c. The yoke 52 is made of a magnetic material. A circular permanent magnet 53 is secured on the yoke 52. A top plate 54 is secured on the permanent magnet 53 and made of a magnetic material. The yoke 52, the permanent magnet 53 and the top plate 54 collectively establish a magnetic flux circuit.

A membrane or diaphragm 55 is molded of resin and has a concentric wavy section. The outer periphery of the diaphragm 55 is joined to the circumferential shoulder 51d of the frame 51. A cylindrical voice coil 56 is attached to the bottom surface of the diaphragm 55. Defined between the yoke 52 and the top plate 54 is a magnetic air gap (g) into which the voice coil 56 extends. A ring 57 is tightly fit within the circumferential shoulder 51d. The ring 57 is placed on the outer periphery of the diaphragm 55 to hold the diaphragm 55 in place. A protective cover 58 has a plurality of sound openings 58a. The protective cover 58 is attached to the upper surface of the ring 57 so as to protect the diaphragm 55.

A printed circuit board 59 has a pair of circuit patterns 59a and a plurality of through holes (not shown). The voice coil 56 has a pair of terminals 56a soldered to the respective circuit patterns 59a. The solder connection is covered with an encapsulating resin 59c. A compression coil spring 60 includes two terminals, one of which is inserted through one of the through holes and soldered to one of the circuit patterns 59a on the printed circuit board 59. The frame 51 has an air vent 51e, and a dust filter 61 is attached to the bottom surface of the frame 51 in such a manner as to cover the lower end of the air vent 51e so that dust and other foreign substance can not enter the interior of the speaker 50.

When an audio signal is delivered to the coil spring 60, the voice coil 56 is vibrated in a substantially vertical direction. This causes the diaphragm 55 to vibrate in the same direction. This vibration produces sound which is then emitted to the outside of the speaker 50 through the openings 58a.

The provision of two separate speakers requires twice as many speaker parts as and is twice as expensive as the provision of a single speaker.

It is, therefore, an object of the present invention to provide a stereo speaker system wherein two speakers are integrated at low cost.

### SUMMARY OF THE INVENTION

According to the present invention, there is provided a stereo speaker system comprising a pair of speakers arranged in a juxtaposed relationship and each including a frame, a yoke supported on the frame, a magnet secured on the yoke, a top plate secured on the magnet, a magnetic air gap defined between the top plate and the yoke, a diaphragm disposed in a confronting relation to the top plate, a voice coil attached to the diaphragm and extending into the magnetic air gap, and a printed circuit board electrically connected to the voice coil, wherein at least one of the frame, the yoke, the diaphragm, and the printed circuit board in one of the two speakers is unitarily connected to corresponding one of the frame, the yoke, the diaphragm, and the printed circuit board in the other speaker.

In one embodiment, the frames of the speakers are unitarily interconnected by a common link portion. The printed circuit boards are integrally formed together and placed on the common link portion of the frames.

In one embodiment, each of the two speakers includes a protective cover secured to the frame and configured to cover the diaphragm. The protective covers of the speakers are unitarily connected together.

In another embodiment, the frame of each of the speakers includes an annular portion shaped to surround the diaphragm. The annular portions of the frames are unitarily interconnected by a common link portion. The diaphragms are unitarily interconnected by a common link portion. The common link portion of the diaphragms is secured to the common link portion of the frames.

In still another embodiment, the frame of each of the speakers includes an annular portion shaped to surround the diaphragm. The annular portions of the frames are unitarily interconnected by a common link portion. The yokes are unitarily interconnected by a common link portion. The yokes each have an outer peripheral edge secured to the annular portions of the frames. The common link portion of the yokes is secured to the common link portion of the frames.

In one embodiment, the frame of each of the speakers includes an annular portion shaped to surround the diaphragm. The annular portions are unitarily interconnected by a common link portion. A pair of rings are provided to press the outer peripheral edge of the respective diaphragms against the respective annular portions.

Preferably, the rings are unitarily interconnected by a common link portion which is secured to the common link portion of the frames. Preferably, the diaphragms are unitarily connected by a common link portion which is sandwiched between the common link portion of the frames and the common link portion of the rings.

In another embodiment, the frame of each of the speakers includes an annular portion shaped to surround the diaphragm. The annular portions are unitarily interconnected by a common link portion. The yokes are unitarily interconnected by a common link portion. The outer peripheral edges of the yokes are secured to the annular portions of the frames. The common link portion of the yokes is secured to the common link portion of the frames. The diaphragms are unitarily interconnected by a common link portion. The common link portion of the diaphragms is secured to the common link portion of the frames.

Preferably, a pair of rings are provided to press the outer peripheral edges of the diaphragms against the respective annular portions of the frames. The rings are unitarily interconnected by a common link portion. The common link portion of the rings are secured to the common link portion of the frames through the common link portion of the diaphragms. Preferably, a pair of protective covers are attached to the respective frames and configured to surround the respective diaphragms. The protective covers are unitarily interconnected by a common link portion. The common link portion of the protective covers is connected to the common link portion of the frames through the common link portion of the diaphragms and the common link portion of the pair of rings.

### ADVANTAGES OF THE INVENTION

According to the present invention, at least one of the frame, the yoke, the diaphragm, and the printed circuit board in one of the two speakers is unitarily connected to at least corresponding one of the frame, the yoke, the diaphragm, and the printed circuit board in the other speaker. This unitary structure brings about a reduction in the number of required parts and the cost of fabrication of the system and also, facilitates assembly of the stereo speaker system.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a top plan view of a stereo speaker system according to the present invention;

FIG. 2 is a sectional view taken on the line II-II in FIG. 1;

FIG. 3 is a bottom plan view of the stereo speaker system;

FIG. 4 is a top plan view of a conventional stereo speaker;

FIG. 5 is a sectional view taken on the line V-V in FIG. 4 and

FIG. 6 is a bottom plan view of the stereo speaker shown in FIG. 4

### DETAILED DESCRIPTION OF THE PREFERRED EMBODIMENTS

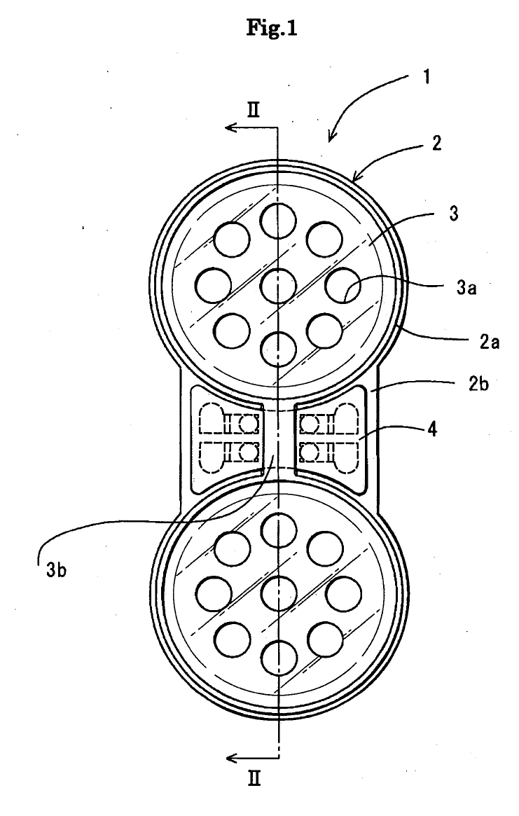

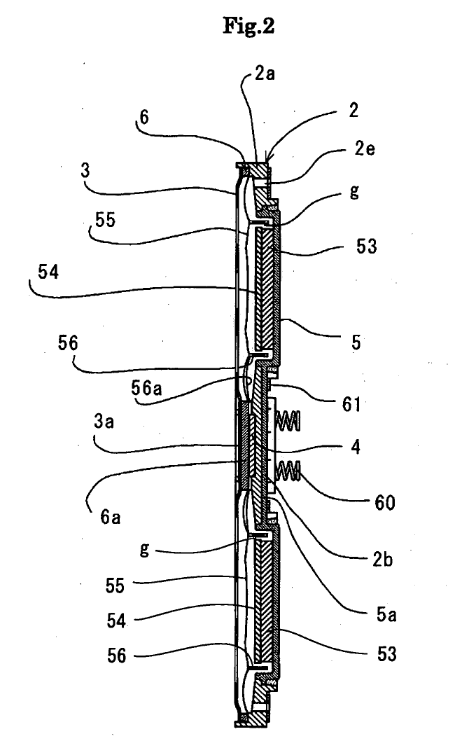

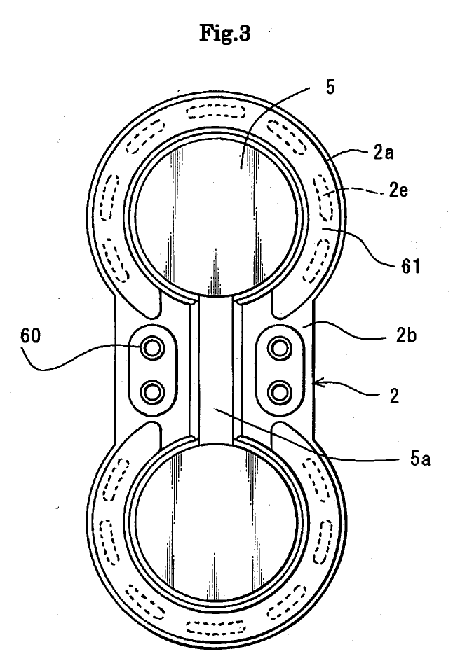

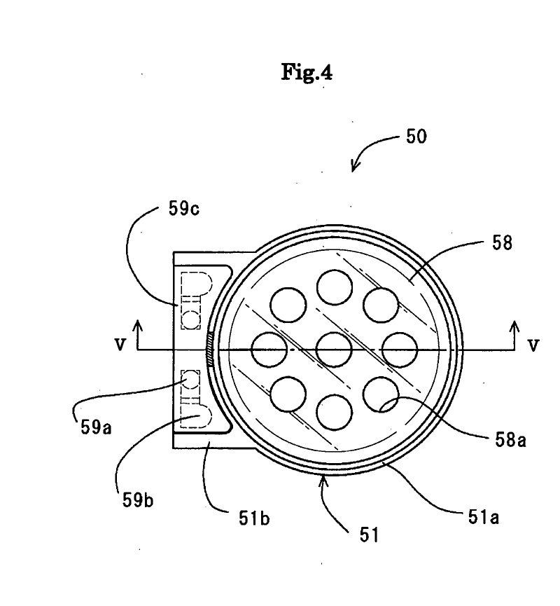

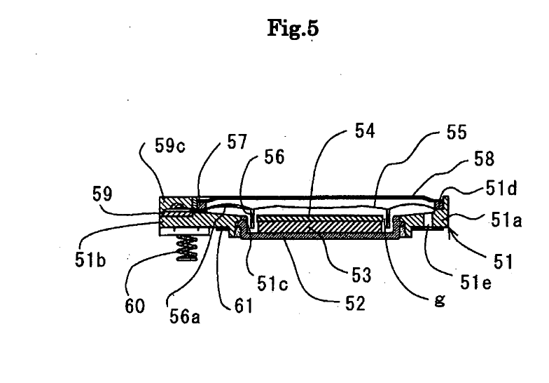

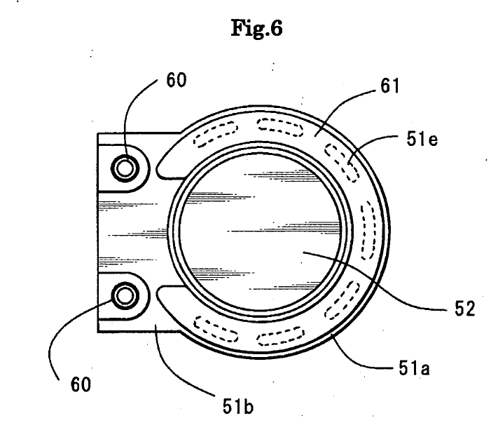

The present invention will now be described with reference to the accompanying drawings. FIG. 1 is a top plan view of a stereo speaker system according to the present invention. FIG. 2 is a sectional view taken on the line II-II in FIG. 1. FIG. 3 is a bottom plan view of the stereo speaker system. Like reference numerals indicate like or corresponding elements shown in FIGS. 4 to 6.

Referring to FIGS. 1 to 3, there is illustrated a stereo speaker system 1 wherein two separate speakers are interconnected through a joint or linkage. Each of the two speakers is similar to the speaker 50 shown in FIG. 4. Also, the linkage is similar to the radial projection 51b shown in FIGS. 4 to 6. Specifically, the stereo speaker system 1 includes a one-piece frame 2 molded of resin and composed of two body portions 2a and a link portion 2b unitarily extending between the two body portions 2a.

A one-piece protective cover 3 is composed of two cover portions, which are similar to the protective cover 58 shown in FIGS. 4 to 6, and a link portion 3b unitarily extending between the two cover portions. A printed circuit board 4 is constructed so that two printed circuit boards, which are similar to the printed circuit board 59 shown in FIGS. 4 to 6, are unitarily interconnected together. A one-piece yoke 5 is composed of two yoke portions, which are similar to the yoke 52 shown in FIGS. 4 to 6, and a link portion 5a unitarily extending between the two yoke portions. A one-piece retainer 6 is constructed so that two rings, which are similar to the ring 57 shown in FIGS. 4 to 6, are unitarily connected through a link portion 6a.

As is understood from the above, the present invention provides a stereo speaker system wherein two separate speaker parts as used in the prior art stereo speaker are interconnected to provide a one-piece structure. This brings about a reduction in the cost of manufacture, the number of required parts, and the number of steps for the manufacture of the stereo speaker system. Advantageously, the printed circuit board is arranged on the link portion of the frame. This arrangement results in a decrease in the overall size of the stereo speaker system.

It should be understood that all the parts not necessarily need to be interconnected together. One or more parts may be divided into two separate parts. Also, the printed circuit boards 4 may be replaced by a lead frame.

The present invention is widely applicable to a cellular phone, a PDA and other portable audio devices.

Although the present invention has been described in terms of specific embodiments, it is anticipated that alternations and modifications thereof will no doubt become apparent to those skilled in the art. It is therefore intended that the following claims be interpreted as covering all such alternations and modifications as fall within the true sprit and scope of the invention.

What is claimed is:

1. A stereo speaker system comprising a pair of speakers arranged in a juxtaposed relationship and each including a frame, a yoke supported on said frame, a magnet secured on said yoke, a top plate secured on said magnet, a magnetic air gap defined between said top plate and said yoke, a diaphragm disposed in a confronting relation to said top plate, a voice coil attached to said diaphragm and extending into said magnetic air gap, and a printed circuit board electrically connected to said voice coil,
at least one of said frame, said yoke, said diaphragm, and said printed circuit board in one of said pair of speakers being unitarily connected to at corresponding one of said frame, said yoke, said diaphragm, and said printed circuit board in the other speaker.

2. A stereo speaker system as defined in claim 1, wherein said frames of said pair of speakers are unitarily connected together by a common link portion, said printed circuit boards being integrally formed together and placed on said common link portion of said frames.

3. A stereo speaker system as defined in claim 1, wherein each of said pair of speakers further comprises a protective cover secured to said frame and configured to cover said diaphragm, said protective covers of said pair of speakers being unitarily connected together.

4. A stereo speaker system as defined in claim 1, wherein said frame of each of said pair of speakers includes an annular portion surrounding said diaphragm, said annular portions of said frames being unitarily interconnected by a common link portion, said diaphragms being unitarily interconnected by a common link portion, said common link portion of said diaphragms being secured to said common link portion of said frames.

5. A stereo speaker system as defined in claim 1, wherein said frame of each of said pair of speakers includes an annular portion surrounding said diaphragm, said annular portions of said frames being unitarily interconnected by a common link portion, said yokes being unitarily interconnected by a common link portion, said yokes each having an outer peripheral edge secured to said annular portions of said frames, and said common link portion of said yokes being secured to said common link portion of said frames.

6. A stereo speaker system as defined in claim 1, wherein said frame of each of said pair of speakers includes an annular portion surrounding said diaphragm, said annular portions being unitarily interconnected by a common link portion, further comprising a pair of rings for pressing an outer peripheral edge of said respective diaphragms against said respective annular portions.

7. A stereo speaker system as defined in claim 6, wherein said pair of rings are unitarily interconnected by a common link portion, and said common link portion of said pair of rings is secured to said common link portion of said frames.

8. A stereo speaker system as defined in claim 7, wherein said diaphragms are unitarily connected by a common link portion, and said common link portion of said diaphragms is sandwiched between said common link portion of said frames and said common link portion of said pair of rings.

9. A stereo speaker system as defined in claim 1, wherein said frame of each of said pair of speakers includes an annular portion surrounding said diaphragm, said annular portions being unitarily interconnected by a common link portion, wherein said yokes each have an outer peripheral edge and are unitarily interconnected by a common link portion, said outer peripheral edges of said yokes being secured to said annular portions of said frames, and said common link portion of said yokes being secured to said common link portion of said frames, and wherein said diaphragms are unitarily interconnected by a common link portion, said common link portion of said diaphragms being secured to said common link portion of said frames.

10. A stereo speaker system as defined in claim 9, further comprising a pair of rings for pressing said outer peripheral edges of said diaphragms against said annular portions of said frames, said pair of rings being unitarily interconnected by a common link portion, said common link portion of said pair of rings being secured to said common link portion of said frames through said common link portion of said diaphragms.

11. A stereo speaker system as defined in claim 10, further comprising a pair of protective covers attached to said respective frames and configured to surround said respective diaphragms, said pair of protective covers being unitarily interconnected by a common link portion, said common link portion of said pair of protective covers being connected to said common link portion of said frames through said common link portion of said diaphragms and said common link portion of said pair of rings.
